(19) United States
(12) Patent Application Publication
(10) Pub. No.: US 2020/0064899 A1
(43) Pub. Date: Feb. 27, 2020

(54) BATTERY PACK CONTROL SYSTEM

(71) Applicant: Microsoft Technology Licensing, LLC, Redmond, WA (US)

(72) Inventors: Gene Robert OBIE, Redmond, WA (US); Yen Ying LEE, Kirkland, WA (US); Sachin R. CHANDRA, Woodinville, WA (US); Jay A. KUEHNY, Sammamish, WA (US); Jason M. BATTLE, Kenmore, WA (US)

(21) Appl. No.: 16/107,241

(22) Filed: Aug. 21, 2018

(51) Int. Cl. G06F 1/32; G06F 1/14; G06F 1/26

(52) U.S. Cl. CPC G06F 1/3212; G06F 1/263; G06F 1/14

(57) ABSTRACT

The described technology provides an apparatus including a battery gas gauge configured to monitor fuel level in a fuel cell of a battery pack, a standby circuit connected to a power output of the battery, the standby circuit configured to receive an enable signal and in response to receiving the enable signal, generate a wake input signal to wake up the battery gas gauge from a shut-down state.

### BACKGROUND

Secondary batteries are used as energy sources of small-sized devices, such as a cellular phone, a laptop computer, and a camcorder, and medium-large sized devices such as an electric car, a hybrid electric car, an electric bicycle, and an uninterruptible power supply (UPS). Lithium-ion polymer batteries, polymer lithium ion, or more commonly lithium polymer batteries (abbreviated Li-poly, Li-Pol, LiPo, LIP, PLI or LiP) are rechargeable batteries (secondary cell batteries). A battery cell accommodating an electrode assembly is coupled to a protection circuit module (PCM), which may include a gas gauge.

### SUMMARY

The described technology provides an apparatus including a battery gas gauge configured to monitor fuel level in a fuel cell of a battery pack, a standby circuit connected to a power output of the battery, the standby circuit configured to receive an enable signal and in response to receiving the enable signal, generate a voltage input signal to wake up the battery gas gauge from a shut-down state.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example computing system including a battery pack control system disclosed herein.

FIG. 2 illustrates an example battery pack system including a bypass circuit disclosed herein.

FIG. 3 illustrates example operations of the battery pack control system disclosed herein to cause a battery pack to enter a standby mode.

FIG. 4 illustrates example operations of the battery pack control system disclosed herein to cause a battery pack to enter the standby mode.

FIG. 5 illustrates an example system that may be useful in implementing the battery pack control system disclosed herein.

### DETAILED DESCRIPTIONS

The technology disclosed herein includes a battery pack control system that may be used with various secondary batteries including lithium polymer (LiPo) batteries to control the various operating states of the battery pack in a fashion to enable additional low power modes for both the pack and any connected loads. The battery pack control system disclosed herein may also include a LiPo battery pack protection control module (PCM) that may contain a high current discharge field effect transistor (FET) (DFET) and charge FET (CFET) connected in a series circuit configuration. These FETs can be controlled to enable or disable battery cell charge or discharge capability as required for protection and normal control. The PCM disclosed herein also uses an integrated microprocessor-based gas gauge (GG) to enable or disable the cell charge or discharge functions. In one implementation, the battery pack design disclosed herein only has this one high current charge/discharge power port available from the battery pack.

An alternative implementation of the battery pack control system disclosed herein allows the gas gauge to enter a low-power state, even when the battery pack output is in a high-power state. For example, the gas gauge (GG) drives a high current DFET while monitoring for potential changes in port current, periodically updating gauging parameters on an interval that minimizes GG power consumptions while at the same time achieving the desired gauging accuracy.

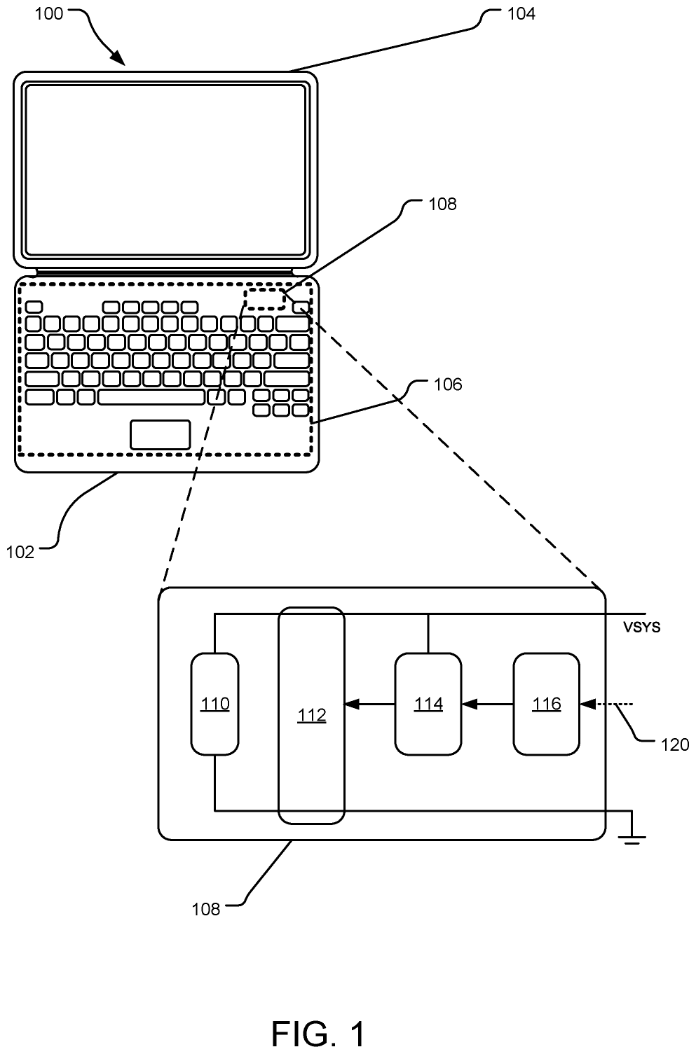

FIG. 1 illustrates a computing device 100 including a battery pack control system disclosed herein. The computing device 100 may be a laptop, a tablet device, a mobile device, or any other device that uses a rechargeable or secondary power source such as a LiPo battery. The computing device 100 may include an input component 102 and an output component 104. The input component 102 may be configured on a mother board of the computing device 100 wherein the mother board 106 may host a number of other components, including a battery pack system 108 that is configured to provide power to various components of the computing device 100.

The illustrated battery pack system 108 may include a fuel cell 110 such as a LiPo fuel cell. A gas gauge module 112 may be provided to gauge the level of fuel in the fuel cell 110 and communicates that information to other components of the battery pack system 108. For example, the gas gauge module 112 may be able to determine the capacity of the fuel cell 110 for life of the fuel cell 110 or for a given cycle of operation. The gas gauge module 112 also provides safety protection to the battery pack system 108 by monitoring the voltage level and disconnecting the fuel cell 110 if it detects a potentially harmful voltage or current level. The gas gauge module 112 may be configured using an integrated circuit (IC) that measures the voltage output by the fuel cell 110 using a resistor and connects or disconnects the fuel cell 110 from the other parts of the battery pack system 108.

The battery pack system 108 also includes a battery pack reset module 114 that is configured to cause the battery pack to enter a standby mode and to exit the standby mode. The battery pack reset module 114 may receive input from a programmable IC module 116. Specifically, the programmable IC module 116 may provide a STANDBY signal to cause the battery pack system 108 to enter a standby mode and a PACK_ENABLE signal to cause the battery pack to exit the standby mode. In one implementation, the programmable IC module 116 may include programmable logic that process inputs 120 from a computing device housing the battery pack system 108 to generate the STANDBY signal and the PACK_ENABLE signal. For example, such inputs 120 from the computing device housing the battery pack system 108 may include a power on signal, an external power plug-in signal.

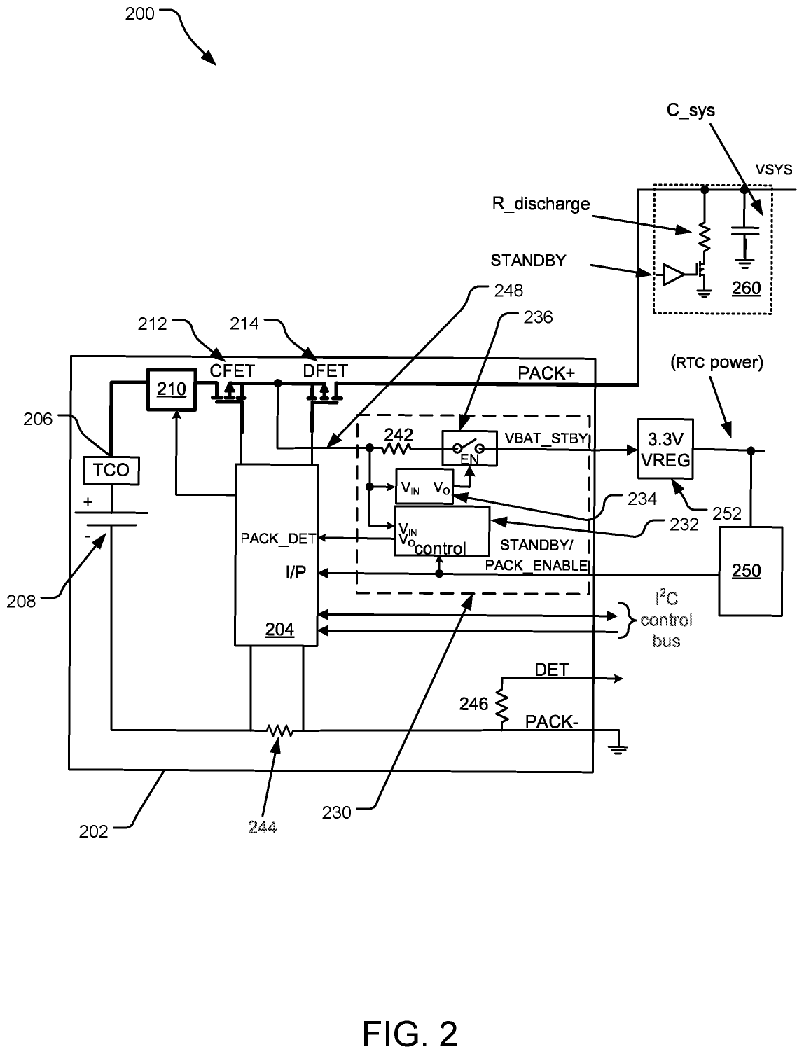

FIG. 2 illustrates an example battery pack system 200 including a battery pack control system 202 disclosed herein. The battery pack control system 202 generates output power between PACK+ and PACK− terminals. In one implementation, the PACK− terminal may also be a ground terminal. In addition, the pack provides a lower power standby voltage for operation of low power control logic external to the pack.

An implementation of the battery pack control system 202 includes a gas gauge module 204 that measures the voltage level using the resistor 244 and uses a charge field effect transistor (CFET) 212 and a discharge field effect transistor (DFET) 214 to cut-off the voltage output from the fuel cell 208. The CFET 212 and the DFET 214 may be formed using metal oxide semiconductor FETs (MOSFETs). Specifically, when the CFET 212 is on, it allows charging the fuel cell 208 whereas if the CFET 212 is off, the charging of the fuel cell 208 is disabled. Similarly, when the DFET 214 is on, it allows discharging the fuel cell 208, whereas if the DFET 214 is of, the discharging of the fuel cell 208 is disabled. Additionally, a chemical fuse 210 may be activated by the gas gauge module 204 if it determines that there is a severe fault. Moreover, a thermal cut-off (TCO) module 206 residing on the body of the fuel cell 208 may measure the temperature of the fuel gauge 208 and if the temperature is above a predetermined threshold, the TCO module 208 may open the circuit to prevent further damage to the fuel cell 208.

The gas gauge module 204 may be controlled over an inter-integrated circuit (I²C) control bus such that allows the gas gauge module 204 to communicate with another microprocessor which may be provided on the mother board of the computing device housing the battery pack.

The gas gauge module 204 receives an input signal at a general-purpose input pin of the gas gauge module 204 from a programmable integrated circuit (IC) 250. In an implementation disclosed herein, the gas gauge module 204 also receives a STANDBY signal on the input pin of the gas gauge module 204. The STANDBY signal may be generated by the programmable IC 250. The programmable IC 250 may be configured to operate at very low current and voltage levels. The programmable IC 250 may generate the STANDBY signal in response to various input signals received from other components of the computing device hosting the battery pack control system 202.

Furthermore, the programmable IC 250 may also generate a PACK_ENABLE signal in response to various input signals received from other components of the computing device hosting the battery pack control system 202. The PACK_ENABLE signal may be communicated to a standby circuit 230 which generates a wake input signal in response to receiving the PACK_ENABLE signal. The wake input signal may be input to a PACK_DET input terminal of the gas gauge module 204.

Entering Standby Mode

The STANDBY signal, when received by the gas gauge module 204, initiates a standby mode. The STANDBY signal may be indicated by the voltage level on the PACK_ENABLE/STANDBY line going low or zero. In the standby mode, the gas gauge module 204 turns of the CFET 212 and the DFET 214 to conserve energy by turning off power output on the main power rail PACK+. However, in the standby mode, the power is still available on a VBAT_STBY rail, which means that the power is still available to run the programmable IC 250 and a clock. Turning off the current on PACK+ rail, which is a high current rail, prevents the leakage of power due to the various active and passive components, such as electrolytic capacitors on the PACK+ rail.

During the standby mode, the gas gauge module 204 also operates in a lower current level. In one implementation, the regular current level mat be approximately 100 micro-amps and the lower current levels may be approximately 1.5 micro-amps. Therefore, operating the gas gauge module 204 in the standby mode also reduces the power consumption by the gas gauge module 204.

When the gas gauge module 204 is operating in standby mode, a standby circuit 230 maintains a voltage on the VBAT_STBY power rail output. The standby circuit 230 includes a resistor 242 to limit the current on the VBAT_STBY power rail for safety and an enable switch 236 that enables output on the VBAT_STBY power rail. The enable switch 236 may be implemented using a FET that is opened by an under-voltage lockout (UVLO) module 234. The UVLO module 234 may be configured with programmable voltage levels and based on the selected voltage level, it disables the enable switch 236 if the V_{IN} signal is below the selected predetermined threshold level. This prevents the fuel cell 208 voltage from dropping below a point where the fuel cell 208 can no longer be charged, rendering the device with the fuel cell 208 in a permanent failure mode. The UVLO module 234 receives an input V_{IN} from the output of the fuel cell 208. The same signal V_{IN} is also input to a standby voltage control module 232. Upon receipt of the V_{IN} signal, the UVLO module 234 opens the switch 236 to allow low current output on the VBAT_STBY rail. The standby circuit 230 generates a VBAT_STBY rail output that is input to the programmable IC 250 via a voltage regulator 252.

The STANDBY signal is also input to a discharge module 260, which allows discharging the voltage on the PACK+ line in response to receiving the STANDBY signal. In one implementation, the voltage on the PACK+ line is discharged through a R_discharge resistor. Due to the discharge of the voltage on the PACK+ rail, the gas gauge module 204 sees low or no signal on the PACK+ rail. In response, the gas gauge module 204 opens the CFET 212 and the DFET 214 to disconnect the output from the fuel cell 208 from the PACK+ rail. Once the battery pack system 200 is operating in the standby mode it operates at current levels of approximately 1.5-2.0 microamps compared to current levels of 100 microamps or higher during normal operations. At this stage, the gas gauge also stops clocking.

Leaving Standby Mode

In one implementation, the programmable IC 250 may receive an input signal when the power button of the computing device housing the battery pack control system 202 is pressed. In response, the programmable IC 250 generates a STANDBY signal to turn off high power output to the system followed by a PACK_ENABLE signal to restore power to the system. Alternatively, the programmable IC 250 also detects hard reset selection on the computing device housing the battery pack control system 202 and in response generates the PACK_ENABLE signal. In yet another implementation, the programmable IC 250 generates the PACK_ENABLE signal in response to detecting plugging in of the computing device housing the battery pack control system 202.

When the PACK_ENABLE signal is high (also referred to as wakeup signal), the standby circuit 230 wakes up the gas gauge module 204. The gas gauge module 204 determines if the signal on the PACK+ is high before it wakes up the remainder of the battery pack control system 202. To ensure that the gas gauge module 204 sees that the signal on the PACK+ line is high when the PACK_ENABLE is high, the standby voltage control module 232 generates a signal V_{O} that is input to a PACK_DET input terminal of the gas gauge module 204. The standby voltage control module 232 uses input from the fuel cell 208 over a line 248 and generates a wake input signal at the terminal PACK_DET. This wake input signal can be transient in nature or steady state as determined by the regulatory and operational requirements for a particular implementation.

An implementation of a gas gauge module 204 may have a very low power state that could implement a “wake on interrupt” feature on a general-purpose input pin. In such an implementation, waking the gas gauge module with the PACK_ENABLE signal may be implemented with a wake input signal on a general-purpose input-output (GPIO) pin on the gas gauge module 204 or a wake voltage to a voltage detector (DET) on the gas gauge module 204. Such implementation of the gas gauge integrated circuits may not require the PACK_DET input discussed above.

The wake input signal at the PACK_DET results in the gas gauge module 204 to interpret a power signal on the PACK+ line, and as a result it wakes up other components of the battery pack control system 202. Thus, in effect, the standby voltage control module 232 causes the gas gauge module 204 to wake up the battery pack control system 202 using a wake input signal that is generated using the power from the fuel cell 208 itself. The gas gauge module 204 closes the CFET 212 and the DFET 214 to allow power from the fuel cell onto the PACK+ rail. In some implementations, the wake signal may be implemented as a transient input signal at the PACK_DET terminal of the gas gauge module in order to reduce the power dissipation and/or to meet regulatory requirements. In one implementation, the length of the wake signal may be approximately 1 ms.

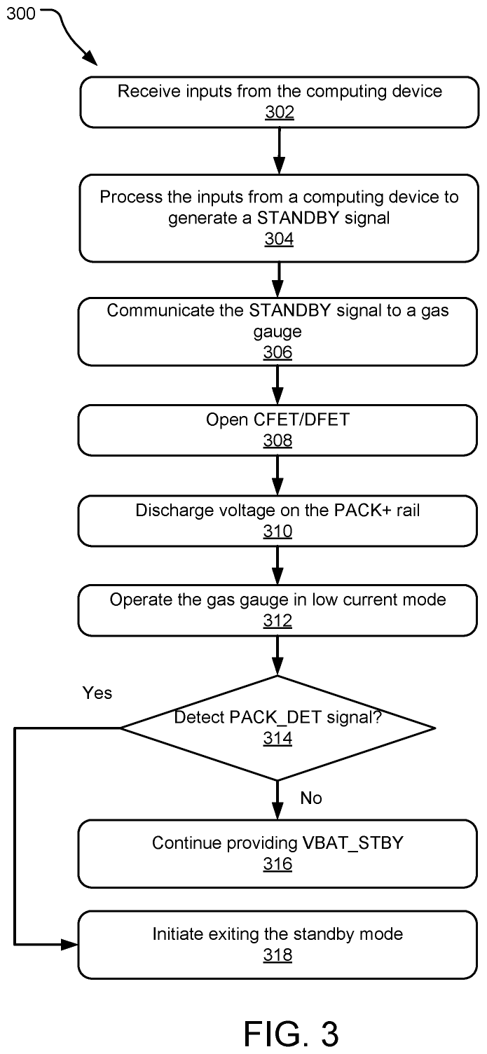

FIG. 3 illustrates a flowchart 300 disclosing example operations of the battery pack control system disclosed herein to cause the battery pack to enter a standby mode. An operation 302 receives various inputs or triggers from a computing device housing the battery pack. In one implementation, a programmable IC receives the inputs or triggers from a computing device, such as a power on signal, a connect to power signal. An operation 304 processes these inputs to generate a STANDBY signal. The STANDBY signal may be implemented by a low level on a STANDBY/PACK_ENABLE line. An operation 306 communicates the STANDBY signal to a gas gauge module of the battery pack. For example, the STANDBY signal may be input to a general-purpose input pin of the gas gauge module.

In response to receiving the STANDBY signal, an operation 308 opens the CFET and the DFET on a PACK+ rail so as to disconnect the fuel cell from the high output power rail. An operation 310 discharges the voltage on the PACK+ rail via a discharge module. Subsequently, an operation 312 operates the gas gauge in a low current mode, which may be approximately 1.5-2.0 micro-amps. In alternative implementations, the low current mode of the gas gauge may be less than 5 micro-amps. An operation 314 determines if a PACK_DET signal is detected at the gas gauge. If not, an operation 316 continues to operate the battery pack in a standby mode and continues providing a VBAT_STBY voltage level that can be used to power external circuitry such as a real-time clock and a programmable IC. If a PACK_DET signal is detected at the gas gauge, an operation 318 initiates exiting the standby mode operation.

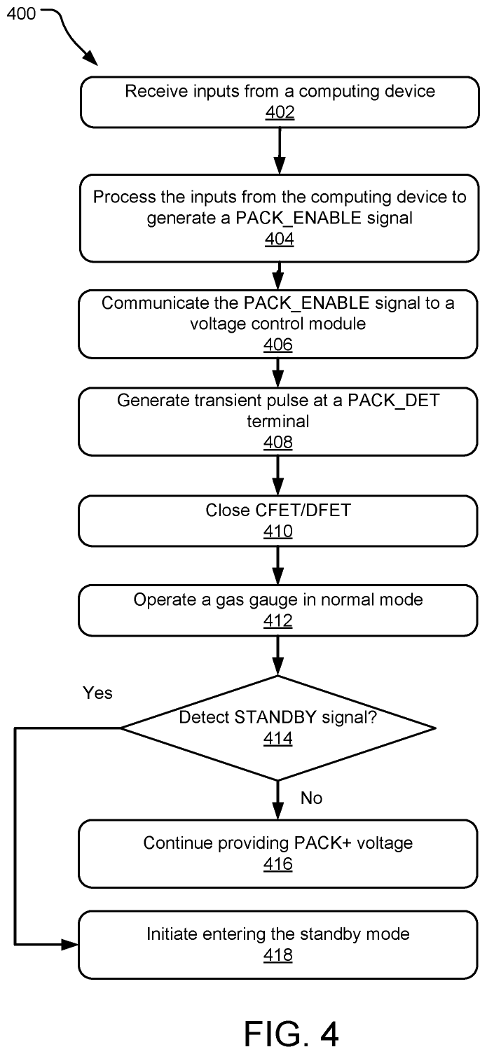

FIG. 4 illustrates a flowchart 400 disclosing example operations of the battery pack control system disclosed herein to cause the battery pack to exit the standby mode. An operation 402 receives various inputs or triggers from a computing device housing the battery pack. In one implementation, a programmable IC receives the inputs or triggers from a computing device, such as a power off signal, a disconnect from power signal. An operation 404 processes these inputs to generate a PACK_ENABLE signal. The PACK_ENABLE signal may be implemented by a high level on a STANDBY/PACK_ENABLE line. An operation 406 communicates the PACK_ENABLE signal to a voltage control module of the battery pack.

An operation 408 generates a transient pulse that is communicated to a PACK_DET terminal of the gas gauge module. This causes the gas gauge to determine that the voltage level on the PACK+ is high and in response an operation 410 closes a CFET and a DFET to allow a fuel cell to be connected to the PACK+ line. An operation 412 operates a gas gauge in a normal mode where it may be operating at current level of approximately 100 microamps or greater. An operation 414 determines if a STANDBY signal is detected at the gas gauge. If not, an operation 416 continues to operate the battery pack in a normal mode and continues the fuel cell to be connected to a PACK+ rail. If a STANDBY signal is detected at the gas gauge, an operation 418 initiates entering the standby mode operation.

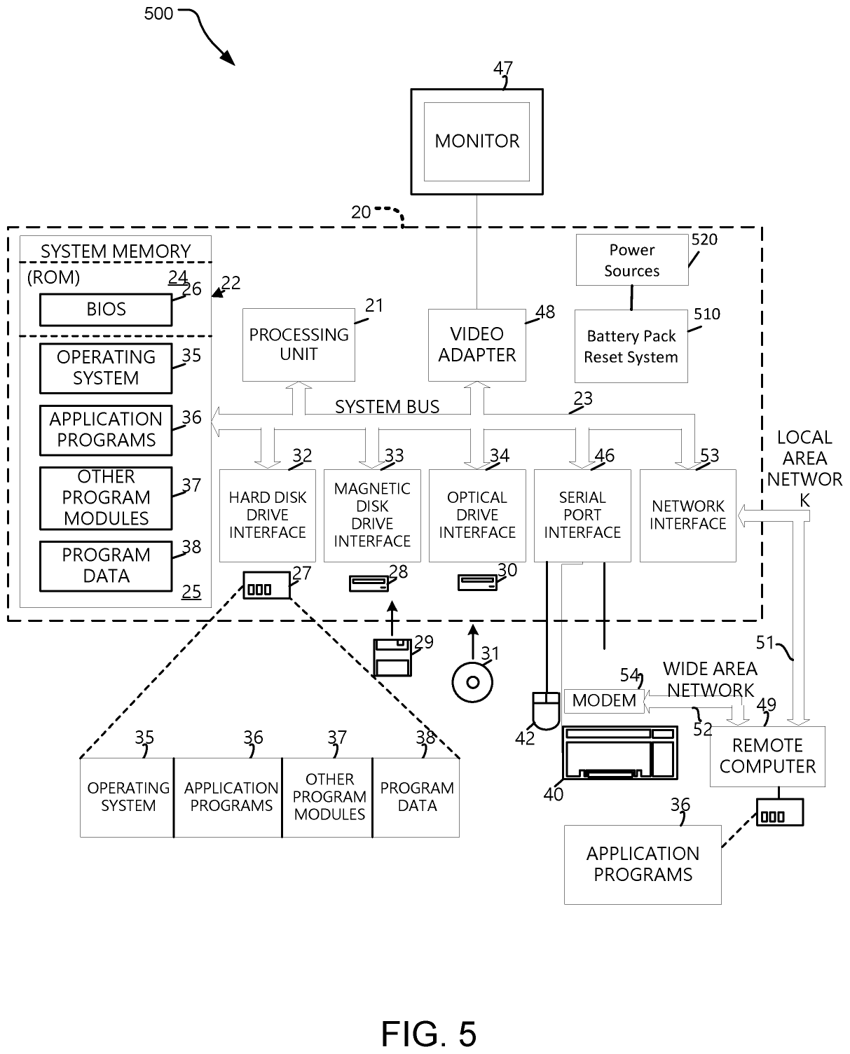

FIG. 5 illustrates an example system 500 that may be useful in implementing the battery pack control system disclosed herein. The example hardware and operating environment of FIG. 5 for implementing the described technology includes a computing device, such as a general-purpose computing device in the form of a computer 20, a mobile telephone, a personal data assistant (PDA), a tablet, smart watch, gaming remote, or other type of computing device. In the implementation of FIG. 5, for example, the computer 20 includes a processing unit 21, a system memory 22, and a system bus 23 that operatively couples various system components, including the system memory 22 to the processing unit 21. There may be only one or there may be more than one processing units 21, such that the processor of a computer 20 comprises a single central-processing unit (CPU), or a plurality of processing units, commonly referred to as a parallel processing environment. The computer 20 may be a conventional computer, a distributed computer, or any other type of computer; the implementations are not so limited.

In the example implementation of the computing system 800, the computer 20 also includes a battery pack control system 510, such as the battery pack control system disclosed herein. The battery pack control system 510 may communicate with power sources 520 to control the level of power provided by the power sources 520.

The system bus 23 may be any of several types of bus structures, including a memory bus or memory controller, a peripheral bus, a switched fabric, point-to-point connections, and a local bus using any of a variety of bus architectures. The system memory 22 may also be referred to as simply the memory and includes read-only memory (ROM) 24 and random-access memory (RAM) 25. A basic input/output system (BIOS) 26, contains the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The computer 20 may be used to implement a battery pack control system disclosed herein. In one implementation, a frequency unwrapping module, including instructions to unwrap frequencies based on the sampled reflected modulations signals, may be stored in memory of the computer 20, such as the read-only memory (ROM) 24 and random-access memory (RAM) 25.

Furthermore, instructions stored on the memory of the computer 20 may be used to generate a transformation matrix using one or more operations disclosed in FIG. 5. Similarly, instructions stored on the memory of the computer 20 may also be used to implement one or more operations of FIG. 4. The memory of the computer 20 may also one or more instructions to implement the battery pack control system disclosed herein.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide non-volatile storage of computer-readable instructions, data structures, program modules and other data for the computer 20. It should be appreciated by those skilled in the art that any type of tangible computer-readable media may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus 23, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device or other common network node, and typically includes many or all of the elements described above relative to the computer 20. The logical connections depicted in FIG. 8 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local area network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of communications devices for establishing a communications link between the computers may be used.

In an example implementation, software or firmware instructions for the battery pack control system 510 may be stored in system memory 22 and/or storage devices 29 or 31 and processed by the processing unit 21. Battery pack control system scheme and data may be stored in system memory 22 and/or storage devices 29 or 31 as persistent data-stores.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments of battery pack control system may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

The battery pack control system disclosed herein may include a variety of tangible computer-readable storage media and intangible computer-readable communication signals. Tangible computer-readable storage can be embodied by any available media that can be accessed by the battery pack control system disclosed herein and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the battery pack control system disclosed herein. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals moving through wired media such as a wired network or direct-wired connection, and signals moving through wireless media such as acoustic, RF, infrared and other wireless media.

An apparatus disclosed herein includes a battery gas gauge configured to monitor fuel level in a fuel cell of a battery pack and a standby circuit connected to a power output of the fuel cell, the standby circuit configured to receive an enable signal and in response to receiving the enable signal, generate a wake input signal to wake up the battery gas gauge from a shut-down state. In one implementation, the wake input signal has a voltage level approximately equal to an output voltage level of the fuel cell on an output rail. In an alternative implementation, the apparatus further includes a programmable integrated circuit (IC) configured to generate the enable signal in response to one or more inputs received from a computing device housing the apparatus.

In an alternative implementation, the programmable IC communicates the enable signal to the standby circuit by setting a high level on an input to the standby circuit. In another implementation, the standby circuit further includes an under-voltage lookout (UVLO) circuit configured to disable an enable switch upon determining that an output voltage level from the fuel cell is below a predetermined threshold. Yet alternatively, the UVLO circuit is configured with a plurality of programmable voltage levels to be compared with the output voltage level from the fuel cell. In one implementation, the battery gas gauge is further configured to close a charge FET (CFET) and a discharge FET (DFET) in response to receiving the wake input signal.

In another implementation, the battery gas gauge is further configured to receive a standby signal from the programmable IC and in response to the standby signal open a charge FET (CFET) and a discharge FET (DFET) connected to the fuel cell. Alternatively, the programmable IC communicates the standby signal to the battery gas gauge by setting a low level to an input terminal of the battery gas gauge. Yet alternatively, the programmable IC generates the standby signal in response to receiving a shutdown signal from a computing device housing the apparatus. In another implementation, the apparatus further includes a discharge module configured to discharge current on an output rail of the battery pack in response to receiving the standby signal.

A method disclosed herein includes generating an enable signal in response to one or more inputs from a computing device housing a battery pack, communicating the enable signal to a standby circuit of the battery pack, generating a wake input signal, and inputting the wake input signal to an input terminal of a battery gas gauge configured to monitor fuel level in a fuel cell of the battery pack. In one implementation, generating the wake input signal further comprising generating either a steady state or a transient wake input signal using voltage signal from an output of the fuel cell of the battery pack.

In an alternative implementation, the wake input signal has a voltage level approximately equal to the output voltage level of the battery pack on an output rail. Yet alternatively, the method includes closing a charge FET (CFET) and a discharge FET (DFET) in response to receiving the wake input signal at the battery gas gauge.

Another method disclosed herein includes generating a standby signal in response to one or more inputs from a computing device housing a battery pack, communicating the standby signal to an input terminal of a gas gauge of the battery pack, and in response to receiving the standby signal opening a charge FET (CFET) and a discharge FET (DFET) connected to a fuel cell of the battery pack. In one implementation, generating a standby signal further comprises generating the standby signal at a programmable IC. Alternatively, communicating the standby signal to an input terminal of a gas gauge of the battery pack further comprising setting a signal level to a low level at the input terminal of a gas gauge of a battery pack. Yet alternatively, the method includes discharging the voltage on an output rail of the battery pack in response to receiving the standby signal. Yet alternatively, the method includes operating the gas gauge in a low current mode in response to receiving the standby signal.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. An apparatus, comprising:
a battery gas gauge configured to monitor fuel level in a fuel cell of a battery pack; and
a standby circuit connected to a power output of the fuel cell, the standby circuit configured to:
receive an enable signal, and
in response to receiving the enable signal, generate a wake input signal to wake up the battery gas gauge from a shut-down state.

2. The apparatus of claim 1, wherein the wake input signal has a voltage level approximately equal to an output voltage level of the fuel cell on an output rail.

3. The apparatus of claim 1, further comprising a programmable integrated circuit (IC) configured to generate the enable signal in response to one or more inputs received from a computing device housing the apparatus.

4. The apparatus of claim 3, wherein the programmable IC communicates the enable signal to the standby circuit by setting a high level on an input to the standby circuit.

5. The apparatus of claim 1, wherein the standby circuit further comprising an under-voltage lookout (UVLO) circuit configured to disable an enable switch upon determining that an output voltage level from the fuel cell is below a predetermined threshold.

6. The apparatus of claim 5, wherein the UVLO circuit is configured with a plurality of programmable voltage levels to be compared with the output voltage level from the fuel cell.

7. The apparatus of claim 1, wherein the battery gas gauge is further configured to close a charge FET (CFET) and a discharge FET (DFET) in response to receiving the wake input signal.

8. The apparatus of claim 2, wherein the battery gas gauge is further configured to receive a standby signal from the programmable IC and in response to the standby signal open a charge FET (CFET) and a discharge FET (DFET) connected to the fuel cell.

9. The apparatus of claim 8, wherein the programmable IC communicates the standby signal to the battery gas gauge by setting a low level to an input terminal of the battery gas gauge.

10. The apparatus of claim 8, wherein the programmable IC generates the standby signal in response to receiving a shutdown signal from a computing device housing the apparatus.

11. The apparatus of claim 10, further comprising a discharge module configured to discharge current on an output rail of the battery pack in response to receiving the standby signal.

12. A method, comprising:
generating an enable signal in response to one or more inputs from a computing device housing a battery pack;
communicating the enable signal to a standby circuit of the battery pack;
generating a wake input signal; and
inputting the wake input signal to an input terminal of a battery gas gauge configured to monitor fuel level in a fuel cell of the battery pack.

13. The method of claim 12, wherein generating the wake input signal further comprising generating either a steady state or a transient wake input signal using voltage signal from an output of the fuel cell of the battery pack.

14. The method of claim 13, wherein the wake input signal has a voltage level approximately equal to the output voltage level of the battery pack on an output rail.

15. The method of claim 12, further comprising closing a charge FET (CFET) and a discharge FET (DFET) in response to receiving the wake input signal at the battery gas gauge.

16. A method, comprising:
generating a standby signal in response to one or more inputs from a computing device housing a battery pack;
communicating the standby signal to an input terminal of a gas gauge of the battery pack; and
in response to receiving the standby signal opening a charge FET (CFET) and a discharge FET (DFET) connected to a fuel cell of the battery pack.

17. The method of claim 16, wherein generating a standby signal further comprises generating the standby signal at a programmable IC.

18. The method of claim 16, wherein communicating the standby signal to an input terminal of a gas gauge of the battery pack further comprising setting a signal level to a low level at the input terminal of a gas gauge of a battery pack.

19. The method of claim 16, further comprising discharging the voltage on an output rail of the battery pack in response to receiving the standby signal.

20. The method of claim 16, further comprising operating the gas gauge in a low current mode in response to receiving the standby signal.
